(19) United States
(12) Patent Application Publication
(10) Pub. No.: US 2002/0077988 A1
(43) Pub. Date: Jun. 20, 2002

(54) Distributing digital content

(76) Inventors: Gary D. Sasaki, Cupertino, CA (US); Mathieu C. Hans, Athens, GA (US)

Correspondence Address: HEWLETT-PACKARD COMPANY, Intellectual Property Administration, P.O. Box 272400, Fort Collins, CO, 80527-2400, US

(21) Appl. No.: 09/741,725

(22) Filed: Dec. 19, 2000

(51) Int. Cl. H04K 1/00; H04L 9/00; G06F 17/60; H04L 9/32; G06F 11/30; G06F 12/14

(52) U.S. Cl. 705/59; 705/51; 713/201

(57) ABSTRACT

Systems and methods of distributing digital content are described. In one aspect, a portable media device includes a memory, a wireless transceiver, an output, and a controller. The memory is configured to store digital content. The wireless transceiver is configured to wirelessly transmit and receive digital content. The output is configured to render digital content. The controller is coupled to the memory, the wireless transceiver and the output, and is configured to control wireless transmission of digital content based upon meta-data associated with the digital content. In another aspect, a digital content distribution system includes two or more portable media devices and a license manager. Each of the portable media devices comprises a memory for storing digital content and a transceiver for wirelessly transmitting digital content to and wirelessly receiving digital content from another portable media device. The license manager is configured to associate digital content with meta-data for controlling wireless transmission and rendering of digital content from one portable media device to another. A content tracking and incentives system that encourages commercial distributors, broadcasters and users to distribute digital content to new potential customers also is described.

### TECHNICAL FIELD

This invention relates to systems and methods for distributing digital content.

### BACKGROUND

Various kinds of information may be presented in a digital content format, including audio, video, text, images and multimedia information. Digital content may be rendered by hardware playback devices and by computer systems operating appropriately configured software playback programs. Hardware playback devices typically are small, lightweight devices having a special purpose processor that renders the digital content stored in memory into audio output or visual output, or both. Software playback programs typically control the output functionality of a computer system to render digital content.

The convergence of technological advances in the compression, storage and transmission of digital data has resulted in a global communications network that allows digital content to be distributed rapidly to a large number of potential customers. At the same time, this technological convergence has enabled unprecedented quantities of digital content to be copied flawlessly and distributed to a large number of people. For example, users easily may exchange unprotected digital files by electronic mail or by direct file transfer over the Internet. Users also may access and download digital content posted on a web page using a conventional web browser application program executing on a computer system.

Digital content owners understandably are concerned about the potential theft and loss of control over the distribution of their works by and between unlicensed users. Cryptographic techniques have been developed to control the distribution of digital content. For example, digital content may be encrypted, and the encrypted content and a decryption key may be transmitted to licensed users. Licensed users may use the decryption key to access the encrypted digital content. External devices (e.g., tokens or dongles) also have been used to control the distribution of digital content. For example, a token or dongle may be required to be connected to a computer or other playback device before a licensed user may access the protected digital content. Still other systems and methods for controlling the distribution of digital content have been developed.

### SUMMARY

The invention features a novel digital content distribution scheme that enables digital content owners to reach new potential customers by leveraging the desire of users to share and exchange digital content, while protecting the commercial interests of digital content owners. The invention enables users to fully enjoy digital content and, at the same time, the invention prevents unchecked distribution of unlicensed digital content. The invention also features a novel content tracking and incentives system that encourages commercial distributors, broadcasters and users to distribute digital content to new potential customers.

In one aspect, the invention features a portable media device comprising a memory, a wireless transceiver, an output, and a controller. The memory is configured to store digital content. The wireless transceiver is configured to wirelessly transmit and receive digital content. The output is configured to render digital content. The controller is coupled to the memory, the wireless transceiver and the output, and is configured to control wireless transmission and rendering of digital content based upon meta-data associated with the digital content.

As used herein, “digital content” refers broadly to any type of electronic content, including text, graphics, data, audio, and video content, and encompasses electronic information that may or may not be subject to copyright or other legal protection.

Embodiments in accordance with this aspect of the invention may include one or more of the following features.

The controller preferably is configured to control playback of digital content stored in the memory based upon a user license confirmation. The controller preferably is configured to confirm a user license for a digital content based upon meta-data associated with the digital content. The controller may be configured to confirm a user license based upon a comparison of a user identifier embedded in the meta-data with a user identifier stored in the memory. The controller preferably is configured to limit playback of the digital content in response to a failed user license confirmation. The controller may be configured to enable playback of only a sample of the digital content in response to a failed user license confirmation. The controller preferably also is configured to enable wireless transmission of digital content stored in the memory in response to a successful user license confirmation.

In some embodiments, the controller is configured to direct received digital content selectively to unrestricted memory storage or to restricted memory storage based upon a user license confirmation. The controller may be configured to direct licensed digital content to unrestricted memory storage and to direct unlicensed digital content to restricted memory storage. The controller may be configured to restrict storage of unlicensed digital works to a predetermined quantity. The controller may be configured to enable wireless transmission of digital content stored in unrestricted memory and to prevent wireless transmission of digital content stored in restricted memory.

The controller may be configured to decrypt encrypted digital content with a cryptographic key stored in the memory.

The output preferably is configured to render audio digital content.

In another aspect, the invention features a digital content distribution system comprising two or more portable media devices and a license manager. Each of the portable media devices comprises a memory for storing digital content and a transceiver for wirelessly transmitting digital content to and wirelessly receiving digital content from another portable media device. The license manager is configured to associate digital content with meta-data for controlling wireless transmission and rendering of digital content from one portable media device to another.

Embodiments in accordance with this aspect of the invention may include one or more of the following features.

The license manager preferably is configured to embed a user identifier in meta-data associated with purchased digital content. The license manager may be configured to allocate incentives based upon meta-data associated with purchased digital content. The license manager may be configured to allocate an incentive to a digital content distributor in response to a purchase of the corresponding digital content by a user of a portable media device storing the meta-data with an appropriate embedded distributor identifier. The license manager may be configured to allocate an incentive to a user of a portable media device containing restricted playback digital content in response to a purchase of the corresponding digital content by the user.

The digital content distribution system may include a licensed digital content distributor that is configured to transmit to one or more portable media devices meta-data associated with a broadcasted digital content and containing an embedded distributor identifier. The licensed distributor may be configured to allocate incentives based upon meta-data associated with purchased digital content. The licensed distributor may be configured to allocate an incentive to a user of a portable media device containing restricted playback digital content in response to a purchase of the corresponding digital content by the user.

Other features and advantages of the invention will become apparent from the following description, including the drawings and the claims.

### DESCRIPTION OF DRAWINGS

FIG. 1 is a diagrammatic view of a system for distributing digital content.

FIG. 2 is a block diagram of a server computer.

FIG. 3A is a diagrammatic front view of a portable media device.

FIG. 3B is a block diagram of components of the portable media device of FIG. 3A.

FIG. 4 is a block diagram of a digital content transfer file and public and private key pairs assigned to a distributor and a licensed user.

FIG. 5A is a flow diagram of a method of packaging digital content for transmission from a license manager to a commercial distributor.

FIG. 5B is a flow diagram of a method of packaging digital content for transmission from a commercial distributor to an end user.

FIG. 6 is a flow diagram of a method of rendering digital content with the portable media device of FIG. 3A.

FIG. 7 is a flow diagram of a method of transmitting digital content with the portable media device of FIG. 3A.

FIG. 8A is a flow diagram of a method by which a commercial distributor may distribute digital content to an end user based upon a stored digital content header.

FIG. 8B is a flow diagram of a method by which a user may access digital content with only a content key and an associated content header.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

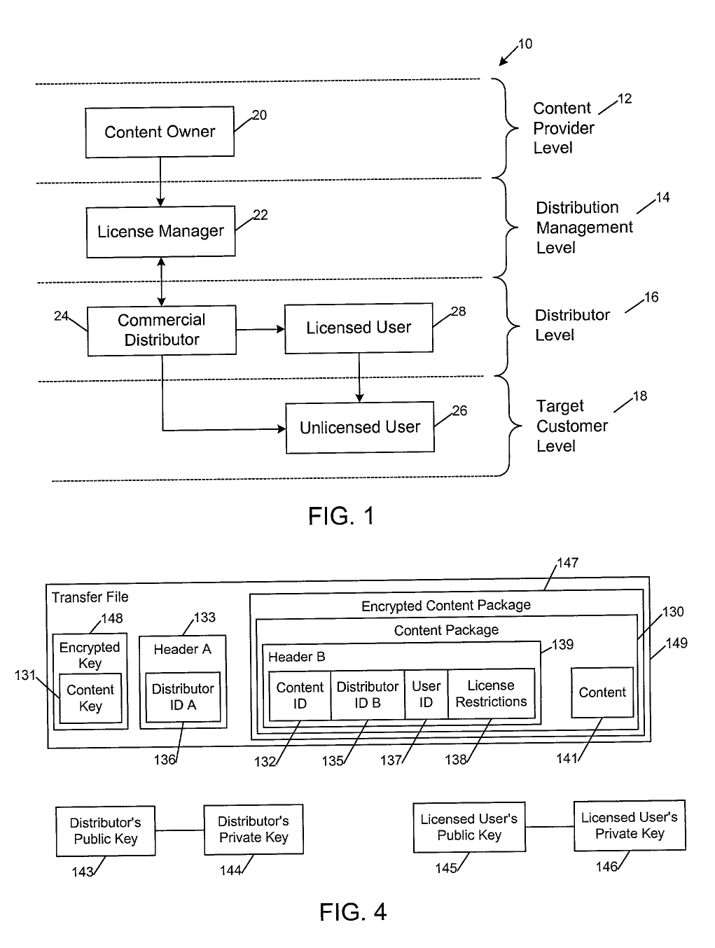

Referring to FIG. 1, in one embodiment, a digital content distribution system 10 has several distribution levels, including a content provider level 12, a distribution management level 14, a distributor level 16, and a target customer level 18. Content provider level 12 includes a content owner 20 that owns the distribution rights for one or more digital works, each of which is encoded in an appropriate digital format. In some embodiments, digital content may be compressed using a compression format that is selected based upon the digital content type (e.g., an MP3 or a WMA compression format for audio works, and an MPEG or an AVI compression format for audio/video works). Distribution management level 14 includes a license manager 22 that is configured to manage digital content licenses for content owner 20 and to track and control the distribution of digital content provided by content owner 20. Distributor level 16 includes a commercial distributor 24 that is configured to sell digital content to an unlicensed user 26 at the target customer level 18. As explained in detail below, distributor level 16 also includes a licensed user 28 who is authorized to distribute digital content to other users, including unlicensed user 26. In this way, digital content distribution system 10 leverages the desire of users to share and exchange digital content to reach new potential customers, while protecting the interests of digital content owners by tracking and controlling the distribution of digital content. License manager 22 also administers an incentives scheme that encourages both commercial distributor 24 and licensed user 28 to distribute digital content and unlicensed user 26 to buy digital content.

In operation, digital content is supplied by content owner 20 to license manager 22. License manager 22 packages the digital content into a secure transfer file, which is transmitted to commercial distributor 24. The transfer file may be transmitted over an open network (e.g., the Internet) or a closed network (e.g., a proprietary dial-up bulletin board). Alternatively, the transfer file may be stored on a mass storage medium (e.g., a CD ROM, a PCMCIA card, a DVD, a floppy disk, a removable hard drive, digital magnetic tape, an optical card, a flash memory or other optical, magnetic, electronic, or semiconductor memory device) that may be physically transferred to commercial distributor 24.

Commercial distributor 24 may offer the digital content for sale to users in a variety of different ways. For example, commercial distributor 24 may operate an Internet web site that may be accessed by a conventional web browser application program executing on a user's computer system. The web site may present a collection of digital content that is indexed and categorized according to traditional criteria (e.g., genre, author, title, top-selling, recommended selections). The web site also may provide additional information relating to the available digital content, including user ratings and reviews. Users may playback the digital content on the fly using a playback software application program. In addition, users may download digital content using a web browser application program and playback the digital content later using the same playback software application program. Users also may transfer the downloaded digital content to an appropriately configured portable media device (described below) that is configured to playback stored digital content. In an alternative embodiment, commercial distributor 24 may operate a traditional brick-and-mortar retail establishment (e.g., a bookstore or a music store) that contains one or more kiosks (or content preview stations) that provide user access to digital content that may be rendered at the kiosk or transferred to a user's portable media device for later playback. A kiosk may include a computer system with a graphical user interface that enables users to navigate through a collection of digital content that is stored locally at the retail establishment or that is stored remotely and is retrievable over a network communication channel. A kiosk also may include a cable port that a user may connect to a portable media device for downloading selected digital content.

As mentioned above, users may playback digital content using a playback software program executing on a computer system or an appropriately configured portable media device. In particular, the playback software and the portable media device are responsive to meta-data associated with each digital work. The associated meta-data includes information that indicates whether a user has purchased a digital work and, therefore is a licensed user 28, or whether the user has received the digital work without purchase and, therefore, is an unlicensed user 26. In one embodiment, licensed users 28 may playback the licensed digital content an unlimited number of times and are allowed to transmit the digital content to other users (both licensed and unlicensed users). Unlicensed users 26, on the other hand, may only playback the digital content a limited number of times, after which they may only play preview sample clips of the unlicensed digital work. In the present embodiment, unlicensed users 26 may not transmit digital content to other users. In other embodiments, unlicensed users 26 may transmit digital content to other users.

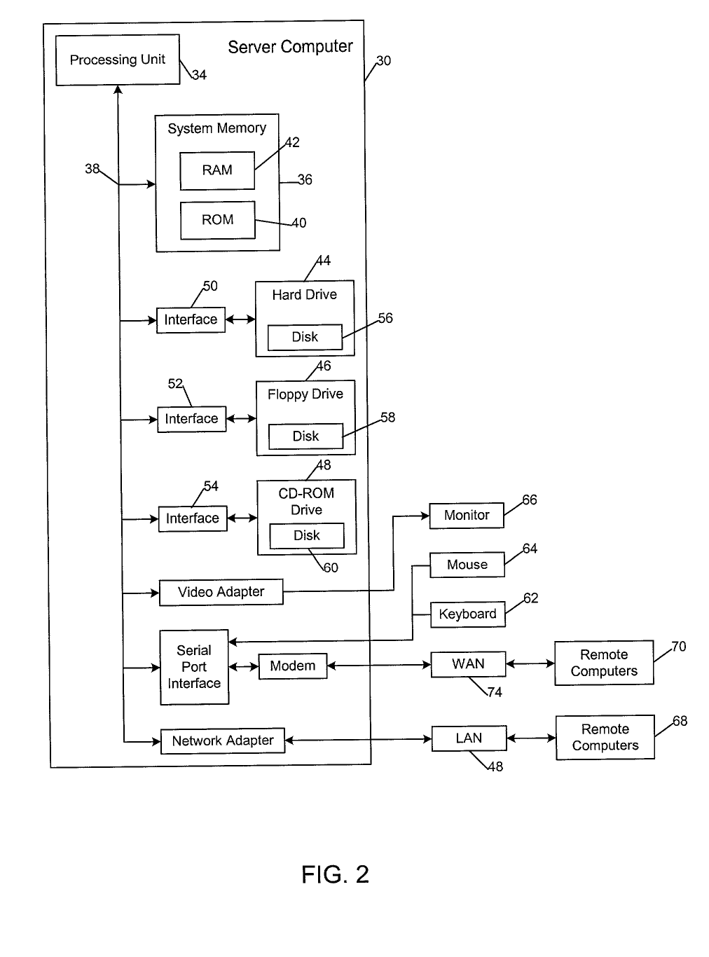

Referring to FIG. 2, in one embodiment, content owner 20, license manager 22, and commercial distributor 24 may communicate and pass digital content over a conventional distribution network infrastructure (e.g., the Internet or a proprietary bulletin board service infrastructure). Accordingly, content owner 20, license manager 22, and commercial distributor each may be implemented as one or more respective software modules operating on a respective server computer 30 that is connected to a conventional telephone or cable network. Server computer 30 includes a processing unit 34, a system memory 36, and a system bus 38 that couples processing unit 34 to the various components of server computer 30. Processing unit 34 may include one or more processors, each of which may be in the form of any one of various commercially available processors. System memory 36 includes a read only memory (ROM) 40 that stores a basic input/output system (BIOS) containing start-up routines for server computer 30, and a random access memory (RAM) 42. System bus 38 may be a memory bus, a peripheral bus or a local bus, and may be compatible with any of a variety of bus protocols, including PCI, VESA, Microchannel, ISA, and EISA. Server computer 30 also includes a hard drive 44, a floppy drive 46, and CD ROM drive 48 that are connected to system bus 38 by respective interfaces 50, 52, 54. Hard drive 44, floppy drive 46, and CD ROM drive 48 contain respective computer-readable media disks 56, 58, 60 that provide non-volatile or persistent storage for data, data structures and computer-executable instructions. Other computer-readable storage devices (e.g., magnetic tape drives, flash memory devices, and digital video disks) also may be used with server computer 30. A user may interact (e.g., enter commands or data) with server computer 30 using a keyboard 62 and a mouse 64. Other input devices (e.g., a microphone, joystick, or touch pad) also may be provided. Information may be displayed to the user on a monitor 66. Server computer 30 also may include peripheral output devices, such as speakers and a printer. One or more remote computers 68 may be connected to server computer 30 over a local area network (LAN) 72, and one or more remote computers 70 may be connected to server computer 30 over a wide area network (WAN) 74 (e.g., the Internet).

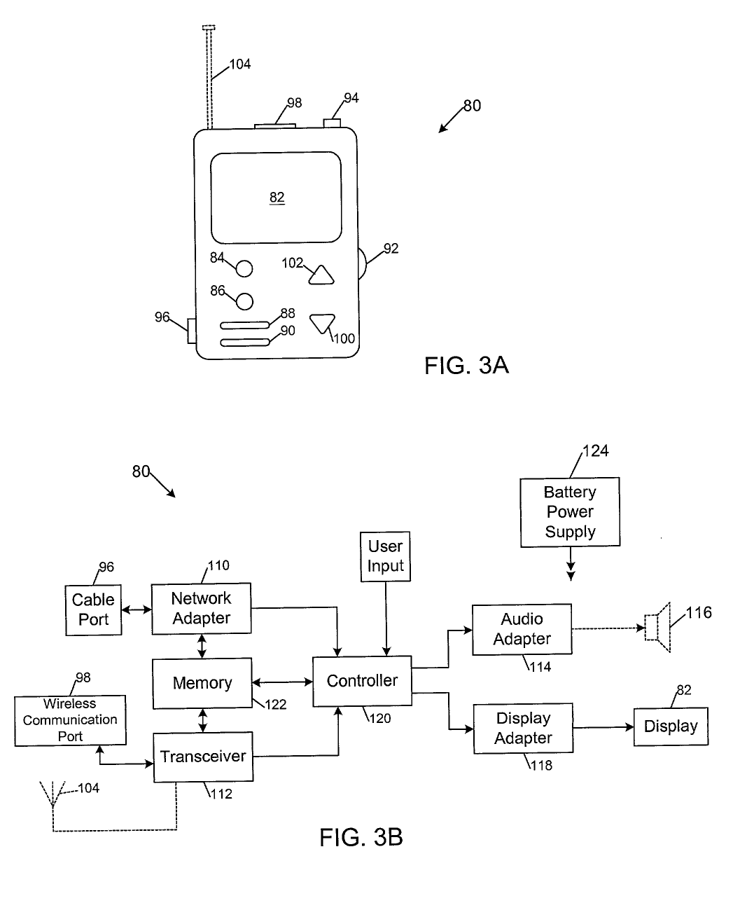

Referring to FIG. 3A, users 26, 28 may access and distribute digital content using a portable media device 80, which is configured to store, render and distribute digital content in accordance with instructions embedded in meta-data associated with each digital work stored in the device. Portable media device 80 includes a screen 82 that displays a graphical user interface to users 26, 28. The graphical user interface may display the title and other information relating to one or more digital works stored in the device. The graphical user interface also may present one or more user options for controlling the operating of portable media device 80. Portable media device 80 also includes various user controls, including a play button 84, a stop button 86, a fast forward/next selection button 88, a rewind/previous selection button 90, and a volume control dial 92. Portable media device 80 has an output port 94 for connecting to an input jack of an audio output device (e.g., headphones), and a cable port 96 for connecting to a computer or other hardware system (e.g., a content preview kiosk system). Portable media device further includes a wireless communication port 98, for example, an IrDA (Infrared Data Association) port, through which portable media device 80 may wirelessly exchange digital content with other similarly configured devices, including other portable media devices. A user may selectively receive and transmit digital content by depressing either a receive button 100 or a transmit button 102. Some embodiments may include an RF antenna 104 instead of, or in addition to, wireless communication port 98.

As shown in FIG. 3B, portable media device 80 has a communication subsystem that includes a network adapter 110 that is configured to communicate through cable port 96 and a transceiver 112 that is configured to communicate through wireless communication port 98 (or antenna 104). Portable media device also has a digital content rendering subsystem that includes an audio adapter 114 that is configured to transmit digital audio data signals to one or more speakers 116, and a display adapter 118 that is configured to transmit image data signals to display screen 82. A controller 120 is configured to choreograph the operation of portable media device 80. As explained in detail below, controller 120 is configured to control the rendering and transmission of digital content that is stored in an internal memory 122 based upon received user inputs and meta-data associated with the stored digital content. Memory 122 may include a random access memory (RAM) and a read only memory (ROM). In some embodiments, one or more other storage technologies may be used, including an internal hard drive and a removable storage device (e.g., a removable hard drive, storage card or disk). A battery power supply 124 supplies the electrical power needed to operate portable media device 80.

In other embodiments, the portable media device may be implemented as a solid state MP3 player, a CD player, an MCD player, a camera, a game pad, a cellular telephone, or other electronic device.

Referring to FIG. 4, meta-data may be associated with digital content to enable license manager 22 to track and control the distribution of digital content and to administer distribution-based incentives. In one embodiment, the meta-data is implemented as a content header 139 (Header B) that includes information relating to an associated digital work 141. For example, content header 139 may include a digital content identifier 132, a distributor identifier 135 (Distributor ID B), a user identifier 137, and license restriction codes 138. Digital content identifier 132 is a unique number that identifies the associated digital work. Distributor identifier 135 and user identifier 137 respectively identify the commercial distributor 24 and the licensed user 28 in the distribution path between license manager 22 and the current holder of the digital work. More than one distributor and user identifiers may be stored in content header 139. License restriction codes 138 contain instructions for controlling the playback of the associated digital content 141, including playback settings and restrictions on the number of times the digital content may be played by an unlicensed user 26. Other information relating to the associated digital content also may be contained in content header 139, including preview sample clips of the associated digital content 141.

Content header 139 is used by license manager 22 to track and control the distribution of digital content 141 and to administer an incentives system that encourages participating entities to distribute digital content 141 to potential new customers. In particular, a license restriction code 138 in each content header 139 limits the number of times that an unlicensed user 26 may playback an associated digital work 141. An unlicensed user 26 may play an unlicensed digital work a number of times up to the playback limit; afterwards, the unlicensed user 26 may only play a preview sample clip of the work. If the unlicensed user would like to play the complete digital work again, the user must purchase the work from a commercial distributor 24. In other words, the distribution of digital content 141 is restricted to a limited number of free playbacks of the digital work and an unlimited number of free playbacks of a preview sample clip of the digital work. As a result, potential new customers are exposed to the digital content being offered for sale without substantial risk of unrestricted distribution of the digital content. The one or more distributor and user identifiers 135, 137, which correspond to the one or more entities in the distribution path between license manager 22 and the unlicensed user 26, may be used by license manager 22 to track the distribution of digital content to end users and to allocate incentives to the distributing entities.

In the present embodiment, license manager 22 transmits the transfer file to commercial distributor 24, which in turn transmits the digital content to end users 26, 28. In some embodiments, license manager 22 also may operate as a commercial distributor. End-users 26, 28 must register their portable media devices and playback software programs with license manager 22 in order to participate in the distribution system 10. During registration, a portable media device is associated with information relating to the owner of the device. The ownership information may be embedded in the portable media device and may be stored in a license database controlled by license manager 22. In addition, each digital work transmission involves the packaging of the digital work and the associated content header into an encrypted transfer file that may be securely transmitted from one participating entity to another. In particular, each digital work and its associated meta-data are encrypted and decrypted with a respective content key. Before encrypted digital content and its associated meta-data and content key are transmitted from one participant to another, the content key is encrypted using the public keys assigned to each of the participants registered with license manager 22. In some embodiments, each of the participating commercial distributors and participating users (licensed and unlicensed) receives a public/private key pair upon registration with license manager 22. The keys may be transferred through a secure software transaction between license manager server 30 and the user's computer system. In some other embodiments, a public/private key pair may be embedded (e.g., hardwired) in the portable media device. The cryptographic keys may be generated in accordance with a conventional encryption algorithm, including RSA and elliptic curve cryptography algorithms. The public keys are transmitted by recipient entities to distributing entities to encrypt the content keys to be transmitted. Transfer files, which include the content, associated meta-data and encrypted content keys, are transmitted to the recipient users. The corresponding private keys are stored in the playback and distribution devices of the participating entities and are not transmitted to other participating entities.

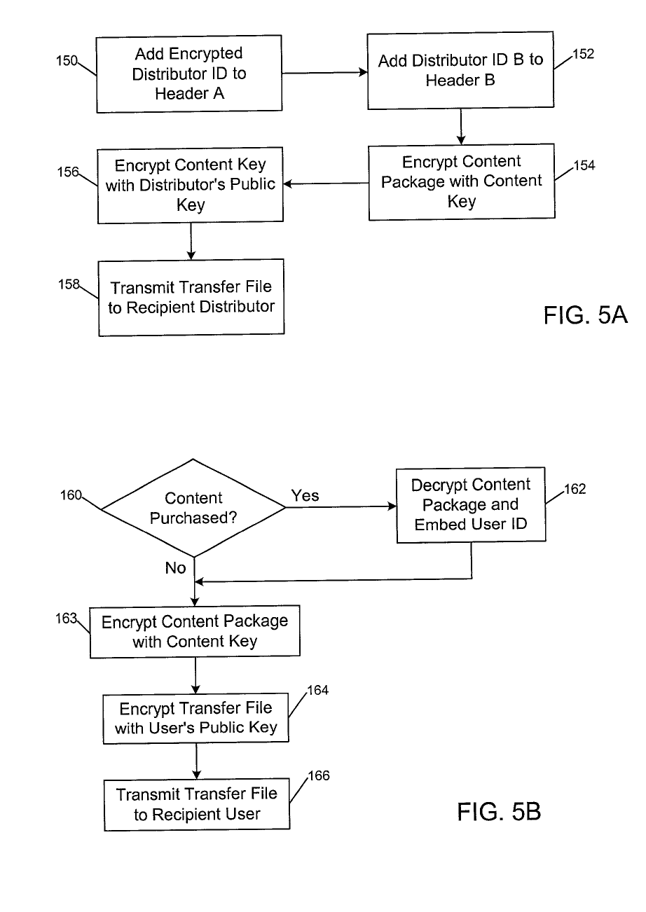

Referring to FIGS. 4 and 5A, in one embodiment, license manager 22 may package digital content 141 and meta-data 139 into an encrypted content package 147 that may be transmitted to a registered distributor as follows. License manager 22 adds a distributor identifier 136 (Distributor ID A) to a first header 133 (Header A) and encrypts the distributor identifier 136 with a single-key that is accessible only by the license manager 22 (step 150). License manager 22 also adds a second distributor identifier 135 (Distributor ID B, which may be the same as Distributor ID A) to a second header 139 (Header B) (step 152). The two distributor identifiers 135, 136 link Header A to Header B, however, a dishonest distributor will not be able to substitute their own distributor identifier because Header A is encrypted by the license manager 22, and therefore is inaccessible. License manager 22 then encrypts the digital content package 130 with a content key 131 (step 154). The content key 131 is used in a simple single-key encryption algorithm (e.g. DES or Triple-DES-Data Encryption Standard) and is not a private/public key type encryption algorithm. This single-key encryption algorithm affords a strong degree of protection, yet requires a relatively lower amount of computation to decrypt with the proper content key 131. Content key 131 is encrypted with the distributor's public key 143 (step 156), which the distributor previously transmitted to license manager 22. The corresponding distributor private key 144 is stored in the memory of distributor server 30, and is not transmitted to license manager 22 or to users 26, 28. Encrypted content package 147, encrypted Header A, and encrypted content key 148 are transmitted to distributor 24 as a transfer file 149 (step 158). Distributor 24 may use its private key 144 to decrypt the encrypted content key 148 in order to access content key 131. Distributor 24 may decrypt the associated encrypted content package 130 with the content key 131.

Referring to FIG. 5B, in one embodiment, commercial distributor 24 may transmit digital content to an end user 26, 28 as follows. If the digital content is purchased by the user (step 160), commercial distributor 24 decrypts the associated content header 139 with the content key 131, and embeds a user identifier 137 corresponding to the recipient user (step 162). The user identifier 137 may correspond to a unique serial number that is assigned to the user during a registration process. The user's identifier 137 also is embedded in the user's portable media device or the user's playback software application program; the user does not have direct access to this identifier. In addition, the license restriction code 138 is set to a full license state. The content package 130 is re-encrypted with the content key 131 (step 163). Using the recipient user's public key 145, commercial distributor 24 encrypts the content key (step 164). Commercial distributor 24 transmits the complete transfer file 149 to the recipient user (step 166).

Once transferred to a playback device, a user may playback or transfer digital content in accordance with the meta-data associated with the digital content. In one embodiment, licensed users 28 may playback the digital content an unlimited number of times and may transfer the digital content to other users, whereas unlicensed users 26 may only playback the digital content a limited number of times and may not transfer the digital content to other users. The following playback implementation is described in connection with the operation of portable media device 80. A playback software application program executing on a user's computer system would operate in a similar manner.

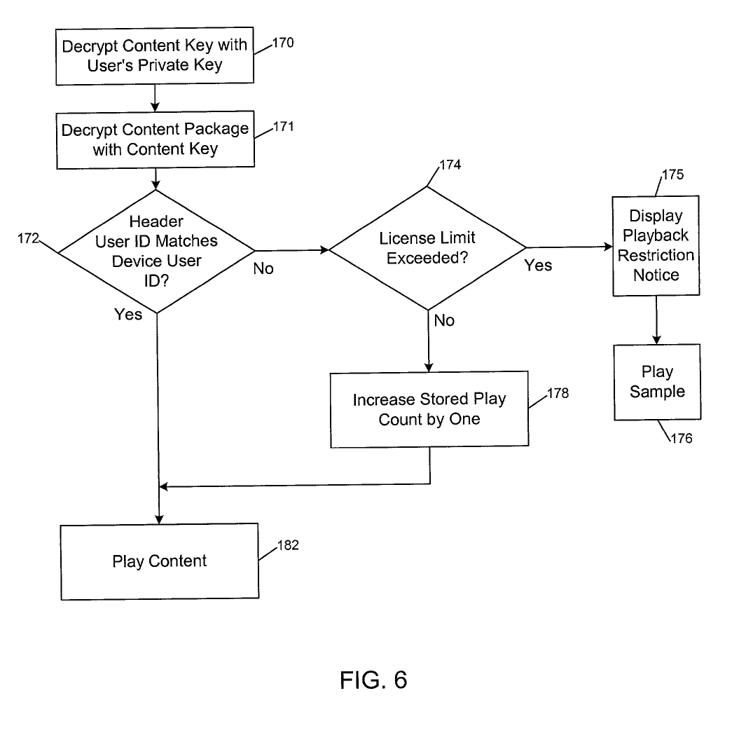

Referring to FIG. 6, in one embodiment, controller 120 of portable media device 80 may render digital content stored in memory 122 as follows. In response to a user request to render a selected digital work stored in memory 122, controller 120 decrypts with the user's private key an encrypted content key 131, which was received from a distributor (either commercial distributor 24 or a licensed user 28) (step 170). Controller 120 then decrypts the encrypted content package 130 with the decrypted content key 131 (step 171). If the user identifier 137 embedded in the content header 139 (Header B) does not match the unique user identifier stored in memory 122 (step 172), the user is an unlicensed user 26. Controller 120 then determines whether the license limit for the digital content has been exceeded (step 174). This determination may be made by examining the license limit stored in license restrictions section 138 of content header 139. The license limit corresponds to the number of times that a particular digital work may be rendered. If the licensed limit is zero (step 174), controller 120 displays a playback restriction notice in display screen 82 (step 175), and allows the unlicensed user to play only preview sample clips of the digital content (step 176). Otherwise, controller 120 decreases the stored play count in the license limit by one (step 178). If the user identifier matches the user identifier stored in portable media device 80 (step 172) or if the license limit was not exceeded (step 174), controller 120 enables portable media device 80 to render the digital content (step 182).

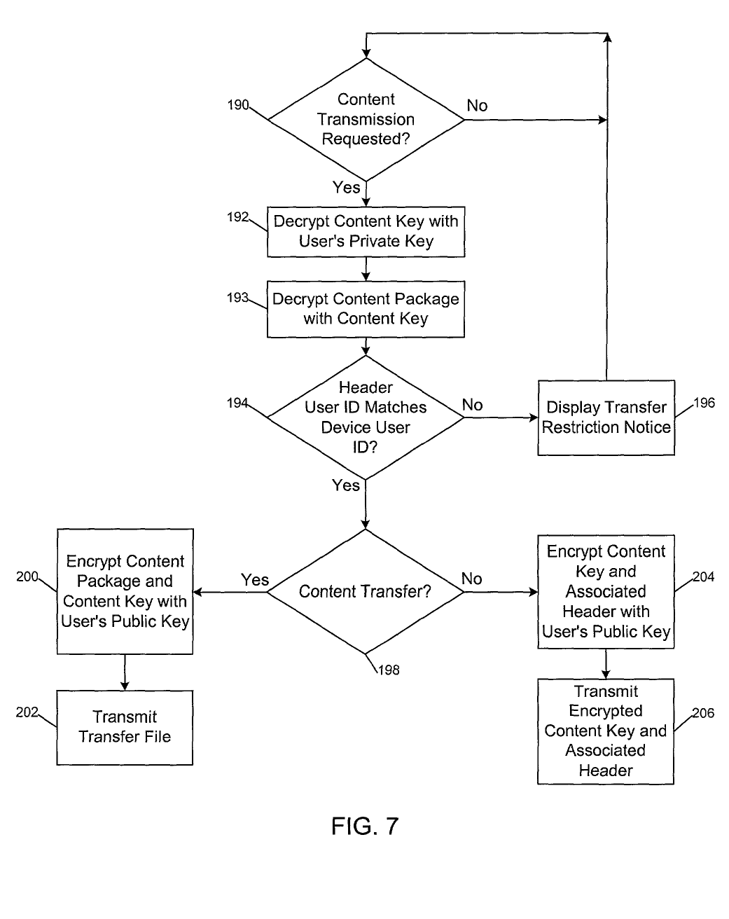

Referring to FIG. 7, in one embodiment, controller 120 of portable media device 80 also enables a licensed user 28 to participate as a distributor of licensed digital content (in unlicensed digital content form) as follows. In response to a user content transmission request (step 190), controller 120 decrypts with the private key stored in device 80 an encrypted content key 131 that was received from a distributor (either commercial distributor 24 or a licensed user 28) (step 192). Controller then decrypts the content package 130 with the decrypted content key 131 (step 193). If the user identifier 137 embedded in the content header 139 does not match the unique user identifier stored in memory 122 (step 194), controller 120 displays a transfer restriction notice in display screen 82 and prevents the unlicensed user from transmitting the selected digital content (step 196). If the user identifier 137 matches the user identifier stored in portable media device 80 (step 194) and if digital content is to be transferred (step 198), controller 120 encrypts the content package 130 and the content key 131 using the recipient user's public key (step 200). Controller 120 then authorizes the transmission of the transfer file 149 to the recipient portable media device (step 202). If content is not to be transferred (step 198), controller 120 encrypts the content key 131 and the associated content header 139 (step 204) and authorizes the transmission of the encrypted content key and encrypted header to the recipient portable media device (step 206).

A user may obtain a license by purchasing a digital work. The digital work may be obtained from a purchased physical medium (e.g., a compact disk) or from a remote computer system (e.g., a commercial distributor web site). A software program operating on a user's computer system and registered with licensed manager 22 may be used to render the licensed digital work and to transfer the digital work to a portable media device or to distribute the digital work to other users (e.g., over the Internet). Before transferring a digital work, the software program may be configured to generate or obtain a content key for the work. The digital content may be encrypted with the content key. The software program also may be configured to generate meta-data for the digital content based upon information stored in the physical medium, the user's registration information or other information (e.g., information obtained from a commercial distributor). The content header also may be encrypted with the content key. The encrypted content package and the encrypted content key may be packaged into a transfer file that is transmitted to the recipient user. The meta-data and content key associated with each digital work not only control a user's access to digital content stored on the user's playback device, but they also enable users to access and playback digital content stored at other locations. Thus, users need to store only content headers and content keys in their playback devices in order to access the corresponding digital content from another source (e.g., a kiosk located in a brick-and-mortar commercial distributor retail establishment, or the portable media device of another user). In this way, a user may maintain access to a large number of digital works in a portable media device despite the memory limitations of the device.

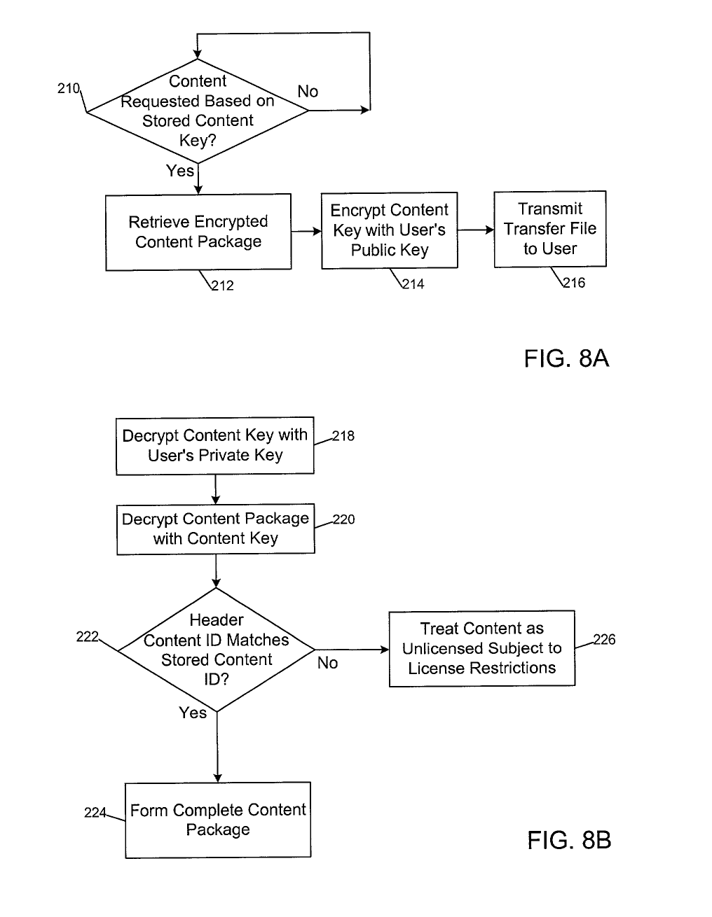

Referring to FIGS. 8A and 8B, in one embodiment, a user of a portable media device storing only a content key 131 with the associated content header may access the corresponding digital content from a commercial distributor 24 as follows. The user connects the portable media device to the device from which the content will be transmitted. Using a kiosk in this example, the user makes a request for the content of interest through the kiosk's interface (step 210). The kiosk retrieves the associated encrypted content package 147, which, in this case, includes license restriction codes 138 set to an unlicensed mode (step 212). The kiosk encrypts the content key 131 with the user's public key 145 (step 214). The resulting transfer file 149 is transmitted to the portable media player (step 216). The portable media player uses the user's private key 146 to decrypt the content key 131 (step 218), which is used to decrypt the encrypted content package 130 (step 220). The portable media player checks the content identifier 132 against the licensed content identifiers stored in memory 122 to determine whether the user had previously purchased a license for the content (step 222). The content identifiers are stored in memory in an encrypted format and are not directly accessible by the user. If the content identifier 132 matches one of the stored content identifiers, the associated content 141 is attached to the associated header 139 (Header B), which is stored in memory 122, to form a complete, unencrypted content package 130 (step 224). Because the user's previously stored Header B contained a full license, the portable media device 80 now may render the content 141 without restriction. If the content identifier 132 does not match any of the stored content identifiers, the content 141 is unlicensed and the associated license restrictions 138 apply (step 226).

A user may upgrade unlicensed content to fully licensed content, usually for a fee, without having to take the time to transfer the full content package. Again, a kiosk is used to illustrate the method. The user attaches the portable media device to the kiosk and through the kiosk's interface conducts the transaction that eventually provides the user with a full license to the content of interest. The kiosk is made aware that the portable media device already has a copy of the content, but that it is in unlicensed form. The kiosk retrieves a fully licensed form of the content file with all the headers, but without the content 141 itself. As before, the content key 131 is encrypted with the user's public key 145 and the complete transfer file 149, without content 141, is transmitted to the portable media player. The portable media player decrypts the package, as described earlier, and notes the match between the received content package and a previously stored unlicensed content package. The new header received from the kiosk is combined with the previously unlicensed content, and a fully licensed content package 130 is created. The unlicensed content header in the portable media player is transmitted back to the kiosk. Commercial distributor 24, owner of the kiosk, may transmit to license manager 22 the one or more distributor/user identifiers that are embedded in the content header, as well as the user identifier corresponding to the user who purchased the digital content.

Unlicensed users 26 who sample a particular digital work may be given a coupon or other discount vehicle to encourage them to purchase the sampled work. In addition, the one or more distributor/user identifiers 135, 137, which correspond to each of the entities in the distribution path between license manager 22 and the unlicensed user 26, may be used by license manager 22 to allocate incentives for each transfer of a digital work that ultimately results in a purchase of the digital work. Users may accumulate incentives in the form of points that may be used to obtain discounts on the purchase of digital content or other designated products being offered for sale by a commercial distributor 24. In some embodiments, users may be allowed to transfer incentive points to one another. Each distributing user may be apportioned a share of a total number of points that is awardable for a given digital content purchase. Commercial distributors may receive incentives in the form of commissions.

User identifier 137 and distributor identifiers 135, 136 in headers 133, 139 are used for tracking where incentive points or commissions should go. The user identifier 137 and the distributor identifiers 135, 136 are sent to license manager 22 whenever a distribution transaction takes place that involves communication to a distributor. Such transactions include the purchase of content via a kiosk or PC and the upgrading of content to a full license. An individual user receives incentive points if the user transfers content to another user in unlicensed form, and the receiving user subsequently purchases a full license. An incentive may be given to a recipient user who connects a portable media player to the PC or kiosk during this transaction. Thus, all user identifiers and distributor identifiers may be accessed and sent to license manager 22.

Other embodiments are within the scope of the claims.

For example, in one embodiment, rather than limit the number of times that an unlicensed user may playback an unlicensed digital work, a portable media device may be configured to limit the number of unlicensed works that may be stored on the device at any given time. In this embodiment, a portable media device has an internal memory that includes an unrestricted area allocated for licensed works and royalty-free works, and a restricted area allocated for unlicensed works. The size of the restricted area may be constrained to limit the number of digital works. The size of the unrestricted area may be unconstrained. After the storage capacity of the restricted memory area has been filled, one or more digital works must be deleted to free a sufficient amount of space for additional unlicensed digital content to be stored in the device. To prevent unchecked distribution of unlicensed digital works, the portable media device is configured to allow a user to transmit to other users only digital content stored in the unrestricted memory area of the portable media device; digital content stored in the restricted memory area may not be transmitted to other users. An unlicensed work automatically is transferred from the restricted memory area to the unrestricted memory area upon purchase of the digital work.

In some embodiments, rather than restrict the number of unlicensed works that may be stored based upon the storage capacity of the restricted area, a portable media device may be configured to limit the number of unlicensed works based upon the actual number of unlicensed works that currently are stored in the device. If the limit has been reached, one of the stored unlicensed works must be deleted before another work may be stored.

In some embodiments, a user with unlicensed content may be allowed to transmit that content in unlicensed form to another user's media player. For example, a user with unlicensed content may be allowed to distribute certain types of royalty free or promotional content. The license restriction codes 138 may be set to indicate that such a transfer is permissible.

The above-described embodiments may be used with a variety of different kinds of digital content distributors. For example, in addition to traditional Internet-based and brick-and-mortar commercial distributors, digital content broadcasters (e.g., webcasters, or traditional radio and television broadcasters) may transmit streaming digital content to end-users. In some embodiments, additional meta-data (e.g., information relating to the associated digital content, a broadcast playlist, advertisements, or a uniform resource locator (URL) of a web site from which additional related information may be obtained) may be transmitted along with the broadcasted digital content. The meta-data may be transmitted in synchronization with the streaming digital content, or out of synchronization with the streaming digital content. Unsynchronized meta-data may include a presentation time stamp that enables suitably configured playback devices to re-synchronize the presentation of the digital content and the associated meta-data. The meta-data may be transmitted in the predefined auxiliary data areas associated with certain digital compression formats (e.g., MPEG). Alternatively, the meta-data may be transmitted in an auxiliary broadcast signal channel. A suitably configured playback device may allow a user to selectively view any meta-data transmitted along with the received digital content. Some playback devices may allow users to store the received meta-data for later playback.

The broadcasted data may include a digital content header 139 and a content key that enable a user to access the corresponding digital content from a commercial distributor 24. The content header may include a broadcaster identifier that may be used by license manager 22 to provide a commission to the broadcaster for any broadcast that resulted in a purchase of digital content. The meta-data also may include an advertisement identifier, which may be used to monitor the effectiveness of advertisements in reaching targeted potential customers.

In some embodiments, the broadcasted meta-data may include preview sample clips of one or more digital works. The meta-data also may include web pages with JAVA applets. In some embodiments, the meta-data may enable users to print out coupons or admission tickets to particular events.

The systems and methods described herein are not limited to any particular hardware, firmware or software configuration, but rather they may be implemented in any computing or processing environment. The encoding, decoding and content rendering processes described above may be implemented in a high-level procedural or object oriented programming language, or in assembly or machine language; in any case, the programming language may be a compiled or interpreted language.

Still other embodiments are within the scope of the claims.

What is claimed is:

1. A portable media device, comprising:
a memory configured to store digital content;
a wireless transceiver configured to wirelessly transmit and receive digital content;
an output configured to render digital content; and
a controller coupled to the memory, the wireless transceiver and the output, the controller being configured to control wireless transmission and rendering of digital content based upon meta-data associated with the digital content.

2. The device of claim 1, wherein the controller is configured to control playback of digital content stored in the memory based upon a user license confirmation.

3. The device of claim 2, wherein the controller is configured to confirm a user license for a digital content based upon meta-data associated with the digital content.

4. The device of claim 3, wherein the controller is configured to confirm a user license based upon a comparison of a user identifier embedded in the meta-data with a user identifier stored in the memory.

5. The device of claim 2, wherein the controller is configured to limit playback of the digital content in response to a failed user license confirmation.

6. The device of claim 5, wherein the controller is configured to enable playback of only a sample of the digital content in response to a failed user license confirmation.

7. The device of claim 1, wherein the controller is configured to direct received digital content selectively to unrestricted memory storage or to restricted memory storage based upon a user license confirmation.

8. The device of claim 7, wherein the controller is configured to direct licensed digital content to unrestricted memory storage and to direct unlicensed digital content to restricted memory storage.

9. The device of claim 7, wherein the controller is configured to restrict storage of unlicensed digital works to a predetermined quantity.

10. The device of claim 7, wherein the controller is configured to enable wireless transmission of digital content stored in unrestricted memory and to prevent wireless transmission of digital content stored in restricted memory.

11. The device of claim 1, wherein the controller is configured to decrypt encrypted digital content with a cryptographic key stored in the memory.

12. A digital content distribution system, comprising:
two or more portable media devices each comprising a memory for storing digital content and a transceiver for wirelessly transmitting digital content to and wirelessly receiving digital content from another portable media device; and
a license manager configured to associate digital content with meta-data for controlling wireless transmission and rendering of digital content from one portable media device to another.

13. The system of claim 12, wherein the licensed distributor is configured to embed a user identifier in meta-data associated with purchased digital content.

14. The system of claim 12, wherein the license manager is configured to allocate incentives based upon meta-data associated with purchased digital content.

15. The system of claim 12, wherein the license manager is configured to allocate an incentive to a digital content distributor in response to a purchase of the corresponding digital content by a user of a portable media device storing meta-data with an appropriate embedded distributor identifier.

16. The system of claim 12, wherein the license manager is configured to allocate an incentive to a user of a portable media device containing restricted playback digital content in response to a purchase of the corresponding digital content by the user.

17. The system of claim 12, further comprising a licensed distributor configured to transmit to one or more portable media devices meta-data associated with broadcasted digital content and containing an embedded distributor identifier.

18. The system of claim 17, wherein the license manager is configured to allocate an incentive to the digital content distributor in response to a purchase of the corresponding digital content by a user of a portable media device storing the meta-data with the embedded distributor identifier.

19. The system of claim 17, wherein the licensed distributor is configured to allocate incentives based upon meta-data associated with purchased digital content.

20. The system of claim 17, wherein the licensed distributor is configured to allocate an incentive to a user of a portable media device containing restricted playback digital content in response to a purchase of the corresponding digital content by the user.
